(19) United States
(12) Patent Application Publication
(10) Pub. No.: US 2006/0015629 A1
(43) Pub. Date: Jan. 19, 2006

(54) System, method, and data structure for processing operating information using information processing devices communicating via a network

(76) Inventors: Masami Mori, Setagaya-ku (JP); Akira Suzuki, Yokohama-shi (JP); Takefumi Hasegawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/168,446

(22) Filed: Jun. 29, 2005

(30) Foreign Application Priority Data
Jun. 30, 2004 (JP) 2004-193781

(51) Int. Cl. G06F 15/16

(52) U.S. Cl. 709/229

(57) ABSTRACT

An information processing device including an interface configured to communicate with a network; an input device configured to generate operating information; an output device; an operating information collecting apparatus configured to collect the operating information of the input device; an operating information sending apparatus configured to transmit the operating information to the network via the interface; an operating information receiving apparatus configured to receive data regarding the operating information returned by the network; and an operating information reflecting apparatus configured to control the output device based on the data received from the network to create an image reflecting the operating information.

### CROSS-REFERENCE TO RELATED APPLICATIONS

This application claims the benefit, pursuant to 35 USC 119(a), of Japanese patent application No. 2004-193781 filed Jun. 30, 2004, the disclosure of which is hereby incorporated by reference.

This application is related to U.S. application Ser. No. 10/662,532 to Koide et al. entitled Data Communication Method, Data Communication Apparatus, Data Communication System and Storage Method filed on Sep. 16, 2003, the disclosure of which is hereby incorporated by reference.

### BACKGROUND OF THE INVENTION

1. Field of the Invention

The present invention generally relates to computer networking systems, data communication methods, and data structures. More particularly, the present invention relates to a system, method, and data structure for processing operating information using information processing devices communicating via a network.

2. Description of the Background Art

U.S. patent application Publication No. 2003/0037111 is directed to synchronizing shared images displayed on plural computers connected via a network. It purports to resolve disagreement between the plural computers regarding changes to the shared displayed images.

Japanese Laid-Open Patent Application 2003-30121 is directed to a web sharing system which is purportedly configured to share a web page provided by the web server with plural communication terminals in order to display plural shared web pages at one time.

Japanese Laid-Open Patent Application 2003-37830 is directed to a client server configuration and purports to shorten information distribution time of display information by reducing the amount of data delivered to a client from a server.

Japanese Laid-Open Patent Application 2003-323386 is directed to collaboration work done via a server which purportedly enables the joint work as a single operation as opposed to various content synchronization operations.

Lastly, both U.S. patent application Publication No. 2003/0014441 and Japanese Laid-Open Patent Application 2003-99424 are directed to document encapsulation.

In recent years, the Internet and connected LANs, both wired and wireless, have thrived. Consequently, many various systems and devices are connected to a network. Various methods and systems for exchanging information over a network are known including chat rooms, instant messaging, E-mail, group ware, web browsers, web server applications, and web services.

In the current environment, many applications operate on stand-alone (i.e., non-networked) computers, but it is becoming increasingly more common that an application works on a networked computer and exchanges information with other networked computers. Networked computers typically are configured in a client server configuration to take advantage of a single machine's powerful processing ability, a distributed processing configuration to enable a plurality of servers to work in cooperation, a peer to peer (P2P) configuration to enable a plurality of computers to exchange information directly, and a grid computing configuration to enable plural computers to work together efficiently.

Deciding whether a computer is used as a stand-alone or in one of the network configurations is a function of how the computer is to be used. For example, it is best to configure the computer as a stand-alone when there is no need to communicate with another computer. The client server configuration is suited for web access, the distributed processing configuration is needed when there is too much load for one server, the P2P configuration is a favored option when the cost of a server is prohibitive, and the grid computing configuration is used to increase the efficiency of plural computers.

In at least one case, when an image display is processed on a peer A based on user operation, the image display data is processed locally. Further, the peer A sends an image display command to a peer B, the peer B receives the image display command and the peer B carries out the image display command. Thus, the peer A processes the image display data for its own display and the peer A sends the image display command to the peer B and peer B processes the image display data for its own display. Consequently, the peer A and the peer B are synchronized.

### SUMMARY OF THE INVENTION

In the above described case, the peer A (a) carries out the image display process locally and (b) sends the image display command to the peer B for processing. The processes and commands of (a) and (b) are almost identical because they are used to display the same image. The current invention addresses this discovered redundancy.

As a consequence of the invention, it is possible to remove the redundancy by configuring the peer A to send the image display command and data to the network and subsequently processing the image display command and data when the data is received back from the network.

In addition, it becomes easy to construct a data service such as data processing or converting data because the data is transmitted directly to a network for processing and bypasses local processing. Even more particularly, it is possible to process data collected from many points because the data is transmitted to the network for processing. In other words, it becomes easy to collect or analyze data.

As thus described, client data is transmitted to a network for processing and the client and other peers on the network can use the same processed data.

In contrast thereto, there is no disclosure in U.S. Laid-Open Patent Application No. 2003/0037111, Japanese Laid-Open Patent Application No. 2003-30121 or Japanese Laid-Open Patent Application No. 2003-323386 to send data including, by way of example, image data from a client to a server for processing and to display an image based on the command(s) and data received from the network.

In addition, there is no disclosure in Japanese Laid-Open Patent Application No. 2003-37830 to display an image without processing an image display command locally, and to display the image display data based on the image display command received from the network.

In summary, it is an object of the present invention to reduce or eliminate redundancy of processing data carried out on a device on a network.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of a network system according to a first embodiment of present invention;

FIG. 2 is a block diagram showing the functional architecture of an information processing device according to an embodiment of the present invention;

FIG. 3 is a flow chart of a process of acquiring operating information according to an embodiment of the invention using an operating information collecting apparatus of an information processing device;

FIG. 4 illustrates an example of data generated by the operating information collecting apparatus according to an embodiment of the invention;

FIG. 5 is a flow chart illustrating the process of an information sending apparatus;

FIG. 6 is a flow chart illustrating the process of an information receiving apparatus;

FIG. 7 is a flow chart illustrating the process of an operating information reflecting apparatus;

FIG. 8 is a block diagram showing the functional architecture of an information processing device according to a second embodiment of the invention;

FIG. 9 illustrates an example of data generated by the operating information collecting apparatus according to another embodiment of the invention;

FIG. 10 illustrates an example of data generated by the operating information collecting apparatus according to yet another embodiment of the invention;

FIG. 11 illustrates an example of data generated by the operating information collecting apparatus according to yet another embodiment of the invention;

FIG. 12 illustrates an example of a table utilized by an information receiving apparatus for routing received data;

FIG. 13 is a block diagram of a network system including a service providing apparatus;

FIG. 14 illustrates an example of data generated by the operating information collecting apparatus providing a translation service;

FIG. 15 illustrates an example of data generated by the information processing apparatus providing an image data smoothing service;

FIG. 16 illustrates an example of data sent by the information sending apparatus of the information processing device according to an embodiment of the invention;

FIG. 17 illustrates an image prior to being subjected to a smoothing service according to the present invention;

FIG. 18 illustrates an example of data generated by the operating information collecting apparatus in order to smooth an image;

FIG. 19 illustrates an image subsequent to being subjected to the smoothing service;

FIG. 20 is a block diagram of an information processing device configured to encode data according to an embodiment of the invention;

FIG. 21 is a block diagram of an information processing device configured to add signature data according to an embodiment of the invention; and

FIG. 22 is a block diagram of a data structure of an encapsulated document according to an embodiment of the invention.

### DETAILED DESCRIPTION OF THE PREFERRED EMBODIMENTS

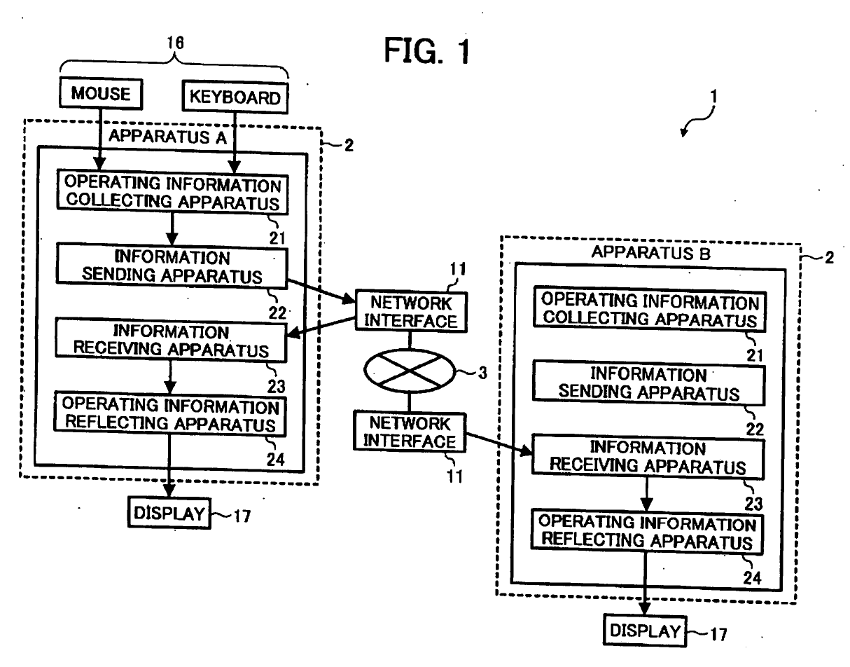

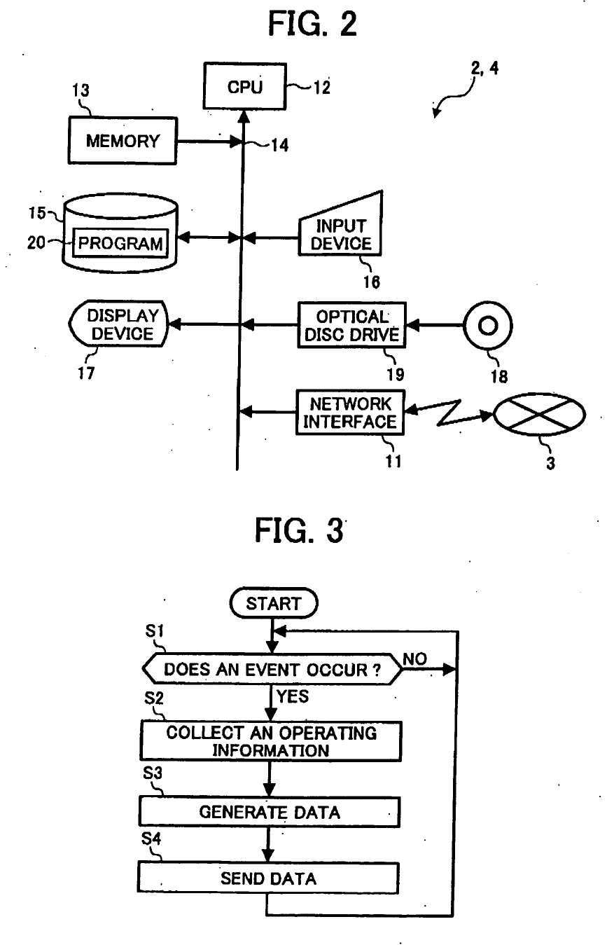

A description will now be given, with reference to drawings of embodiments of the present invention in which like reference numerals indicate identical or corresponding parts throughout the several views. FIG. 1 is a block diagram of a network system according to a first embodiment of present invention. FIG. 2 is a block diagram of the hardware architecture of an information processing device according to an embodiment the present invention. There are plural information processing devices connected to each other in a P2P configuration on network 1. By way of example, only two information processing devices (2, 4), Apparatus A and Apparatus B, are shown in FIG. 1.

As can be seen from FIG. 2, the information processing devices 2 and 4 each have a CPU 12 which controls every part of information processing devices 2 and 4 via a bus 14. The information processing devices 2 and 4 each have a memory 13 including ROMs and RAMs connected via the bus 14.

A storage device 15, for example a hard disk, an input device 16, for example a keyboard and/or a mouse, a display device 17, an optical disc drive 19 for reading data from optical disc 18, and a network interface 11 for communicating to the network 3 are each connected to the bus 14 via interface to communicate with one another.

The optical disc 18 may be a CD or a DVD; however, an optical magnetic disc, a flexible disc, or the like, may be used instead of the optical disc 18. Of course, if an optical magnetic disc is used in lieu of the optical disc 18, then an optical magnetic disc drive or a flexible disc drive would be used instead of the optical disc drive 19.

A program 20 stored on the storage device 15 can be installed from the optical disc 18 using the optical disc drive 19. According to a preferred embodiment, the program 20 is downloaded and installed from the Internet via the network 3. Alternatively, program 20 can be hard coded as a chip connected to the bus 14 in lieu of being stored by storage device 15. Each information processing device 2 and 4 executes the program 20 to complete a predetermined process.

The program 20 is an application running on an operating system (OS) such as Windows (TM), UNIX (TM), or Mac (TM). The program 20 is configured to communicate or exchange data of the information processing devices 2 or 4 over the network 3. The OS can activate the program 20, and read or save information depending upon user operations. The network interface 11 supplies a signal to network 3 to enable the information processing device 2 to communicate via the network 3, but the OS intervenes between all transmissions to and from the information processing device 2 communicated via the network interface 11. In addition, analysis of the signals received by the network interface 11 received from the network 3 for the information processing device 2 should be completed. If the analyzed data is identified as operational data, then the data is accepted and processed by the information processing device 2. If the data is not operational data intended for the information processing device, then the data will be canceled or discarded. All communication of data from the information processing device 2 intended for the network 3 goes by way of the network interface 11 including transmission and reception of an E-mail or the exchange of data by the Transmission Control Protocol/Internet Protocol (TCP/IP). In summary, the program 20 is configured to instruct the CPU 12 to exchange information over the network 3 by generally exchanging data to be communicated via the network interface 11 using the OS.

Because of the above described hardware architecture, each information processing device 2 or 4 can accomplish a myriad of information processing. In addition, the network 3 can be communicated with via the network interface 11. A description is now provided of processing which can be accomplished using the information processing device 2 or 4 in light of the program 20.

FIG. 1 illustrates the functional components of the information processing device 2. The information processing device 2 includes an operating information acquisition apparatus 21 configured to acquire an event occurrence of a user operating input device 16 such as a mouse or a keyboard, an information sending apparatus 22 configured to transmit operating (event) information regarding this internal event to the network 3 via network interface 11, an information receiving apparatus 23 configured to receive the operating (event) information back from the network via the network interface 11, and an operating information reflection apparatus 24 configured to interpret the received data indicative of, by way of example, an image to be displayed on the display unit 17. The functional components of the information processing device are provided by way of program 20.

FIG. 3 is a flow chart illustrating the steps of a method according to an embodiment of the invention using, among other things, the operating information collecting apparatus 21 of the information processing device 2. In step SI, it is determined whether an event has occurred regarding the input device apparatus 16 (e.g., movement of the mouse or typing using the keyboard). If the answer is yes, then in step S2 the operating information collecting apparatus 21 acquires (collects) the event information. If no event has occurred, the process loops back until an event has been detected. If operating information has been acquired, the operating information collecting apparatus 21 generates and sends event data (operating information) to the information sending apparatus 22 for transmission on the network via network interface 11. For example, the coordinate information of a mouse movement is collected by collecting apparatus 21. If it is determined that the acquired data is operating information, then according to the invention, the information processing device 2 does not reflect on the display device 17 that the mouse has been moved. Rather, the information sending apparatus 22 sends the operating information received from the operating information collecting apparatus 21 to the OS layer along with the IP address of the device 2 and a port number to use. The port number is necessary to determine whether the data is operating information. Port numbers are assigned to protocols and services such as the service described herein.. The port number 80 is generally used for World Wide Web HTTP and the port number 25 is used for Simple Mail Transfer Protocol. The information sending apparatus 22 broadcasts the operating information data to each information processing device on the network system 1 via the network interface 11 and the network 3.

The broadcasting of the operating information data results in the operating information data being transmitted back to the originating information processing device. The information receiving apparatus 23 receives the transmission of the message data over the network interface 11 and the OS. The received data is then sent to the operating information reflecting apparatus 24 as if it were operating information received directly from the input device 16. The operating information reflecting apparatus 24 uses the operating information received from the information receiving apparatus 23 to direct the display device 17 to display an image based on the received data. For example, an image of a line in accordance with the operating information of a mouse is shown on the display device 17.

As thus described, acquired operating information is not displayed before the operating information data is forwarded to the network 3. The network 3, in response, transmits a message including the operating information data back to the information processing device 2. Upon receiving the message generated by the network 3, the information processing device creates an image to be displayed.

The operating information indicating the user operation is included in the data sent from the information sending apparatus 22 to the network interface. The operating information is subsequently transmitted to network 3, but as for the return of this operating information, the information processing device 2 receives a message regarding at least operating information of the information processing device 2 from the network 3. The transmitted message may also include data regarding other information processing devices on the network system 1. In other words, in transmitting message data, including operation information data back to the information processing device 2, instructions received by the network 3 regarding operating information for all other information processing devices on the network system 1 are included. The transmission of a message to the information processing devices is preferably completed using both a broadcast and unicast communication, but address information showing the information processing device 2 that the transmission of a message is, as necessary, ahead should be included.

When the same operating information which is transmitted to information processing device 2 is transmitted to other information processing devices on the network, a change in image of the display on the respective display devices of the information processing devices is synchronized with the display of the information processing device 2. Moreover, the sequence of the display changes is maintained at each of the information processing devices.

Again regarding FIG. 1, synchronization of operation information regarding two information processing devices 2 (an Apparatus A and an Apparatus B) is illustrated with arrows reflecting data flow. As discussed above, Apparatus A acquires operating information of a user from a mouse, a keyboard, or the like and sends the data to a network interface 11 via the information sending apparatus 22. The information sending apparatus 22 sends a broadcast address and a port number to employ to the OS along with received operating information data. The network 3 broadcasts message data to the network interface 11. In response to the broadcast message, both Apparatus A and Apparatus B interpret the transmission of the message data to determine if it includes operating information regarding its own device. If the message data is intended for the information processing device, it is received and used.

The information receiving apparatus 23 of both information processing devices shown in FIG. 1 subsequently receive the transmission of the message data via the OS layer. The Apparatus A and the Apparatus B then send the received operating information to their respective operating information reflecting apparatuses 24. The operating information reflecting apparatus 24 uses the received information, and displays an image based on the received operating information including the information and the subject matter of an occasion. As thus described, acquired operating information is transmitted to the network 3 once, the data that the transmission of a message is caused by, and is transmitted a message by the network 3 are received, these data are taken advantage of the information processing device 2. Thus, the operating information can be processed in the same sequence by information processing devices 2 and 4 and hence converted to image data on the respective display devices in a synchronized manner.

As can be seen from FIG. 1, the operating information collecting apparatus 21 acquires the operating information of a user operating the input device 16. The acquired operating information data is sent to the information sending apparatus 22. For example, information is acquired reflecting a clicking of the mouse to select an item, a transfer of a mouse movement, a position of a mouse pointer during a drag operation, a position of entry or exit of a mouse pointer to an appointed prescribed area, or key information input with the keyboard. A flow of processing of the operating information collecting apparatus 21 is shown in FIG. 3. In other words, the operating information collecting apparatus 21 awaits an event regarding operation of the mouse, the keyboard, or other input device (step S1). When an event occurs, the operating information collecting apparatus 21 acquires the events as operating information (step S2). The acquired operating information is converted into operating information data which can be utilized by information sending apparatus 22 (step S3), and then the data is sent to the information sending apparatus 22 (step S4).

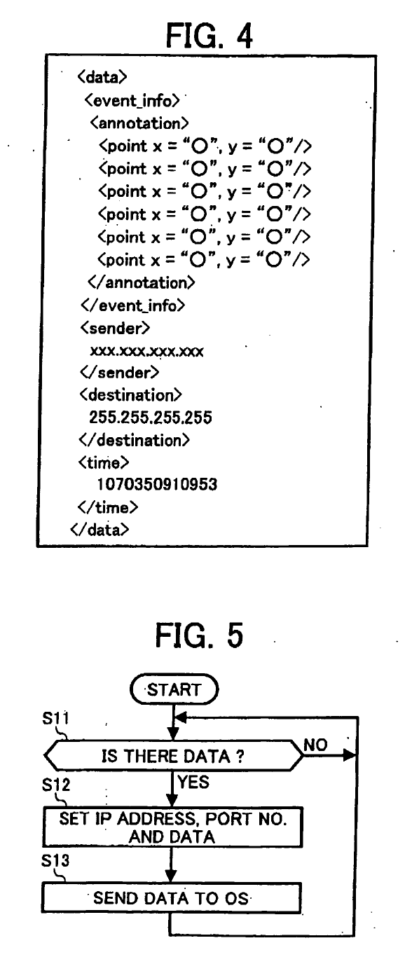

The operating information data generated in step S3 and sent to the information sending apparatus 22 in step S4 includes the operating information, an IP address of the sender device, a destination IP address, and transmission of the acquisition time of the operating information. As shown in FIG. 4, it is easy to convert the information into data when the data is generated in an XML format (a tree object). The acquired operating information is associated with an event_info tag as shown in FIG. 4. In the example of FIG. 4, the acquired points (x, y) of movement of the mouse, which in this example are identified by tags as “event_info” generally and “annotations” in particular, are provided as data. In the information receiving apparatus 23, the received data is acquired on the basis of the tag information reflecting that the data is event information. When the tags do not reflect that the data can be interpreted, the data is canceled or discarded. An IP address of sender is described in the sender tag, a broadcast address is described in the destination tag, and a sending time is described in the time tag. A sender tag and a destination tag are defined before the operating information is acquired. After having acquired the operating information, the event_info tag is created. When the operating information acquisition time is provided as a time tag, data to send to the information sending apparatus 22 is generated. In addition, an IP address in the destination tag is sent to the information sending apparatus 22 when sending data to the information sending apparatus 22.

An example of the flow of processing of data at the information sending apparatus 22 of an information processing device is shown in FIG. 5. The information sending apparatus 22 awaits reception of the IP address of a destination device and operating information data in XML form (a tree object) from the operating information collecting apparatus 21 in step S11. Upon receiving that data, the information sending apparatus 22 sends the received data to the OS (step S 13). The data sent to the OS are the IP address, a port number, and the operating information data needed to transmit a message (step S12). The data is converted into binary data. When the OS receives the data, the data is sent to the network interface 11. The network interface 11 formats and manipulates the data such that it can be transmitted to the network. A header may be added, and the data is thereafter sent (broadcast) to the network 3.

An example of a broadcast communication was discussed above. However, in the case of unicast communication, the operating information collecting apparatus 21 acquires the destination IP address which is predetermined or input by a user, and the data is sent in the previously described XML format.

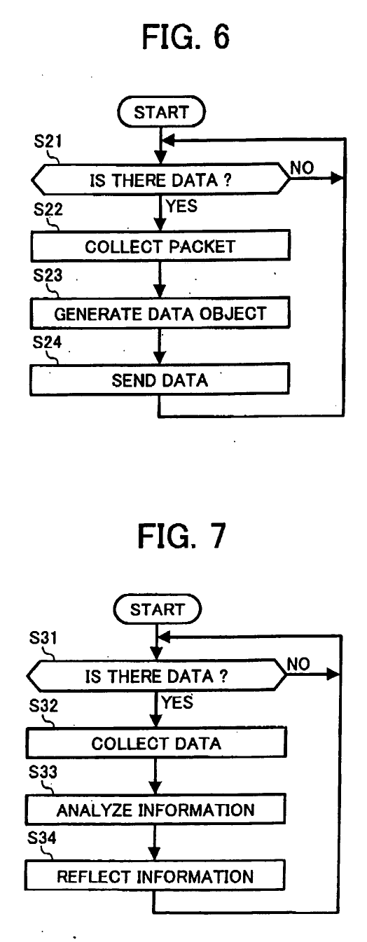

An example of the flow of processing of data at the information receiving apparatus 23 of an information processing device is shown in FIG. 6. The information receiving apparatus 23 awaits reception of a packet of data from the OS (step S21). If the packet is acquired (Y of step S21, S22), a data object is generated from the acquired packet (step S23), and the data object is sent to the operating information reflecting apparatus 24 (step S24). The data is a tree object (i.e., is in an XML format).

An example of the flow of processing of data at the operating information reflecting apparatus 24 of an information processing device is shown in FIG. 7. The operating information reflecting apparatus 24 interprets data received from the information receiving apparatus 23. In this case, an annotation tag provided in the tree object reflects that information data regarding, for example, mouse position data has been acquired. Consequently, the information data is converted into data which can be processed and displayed by the display device 17. If the data object did not have a tag reflecting that the data was operating information data, then the data object would be discarded or ignored.

The above-described example was directed to a mouse event. However, the operating information does not have to be limited to mouse operations but could include input operation from a keyboard, or the like, in addition to a mouse or other known input device (e.g., a joystick). In addition, there are many cases where position information of an image where a mouse click or selection occurs as an operation. Many of these operations are processed independently, and need to be distinguished by the operating information reflecting apparatus 24.

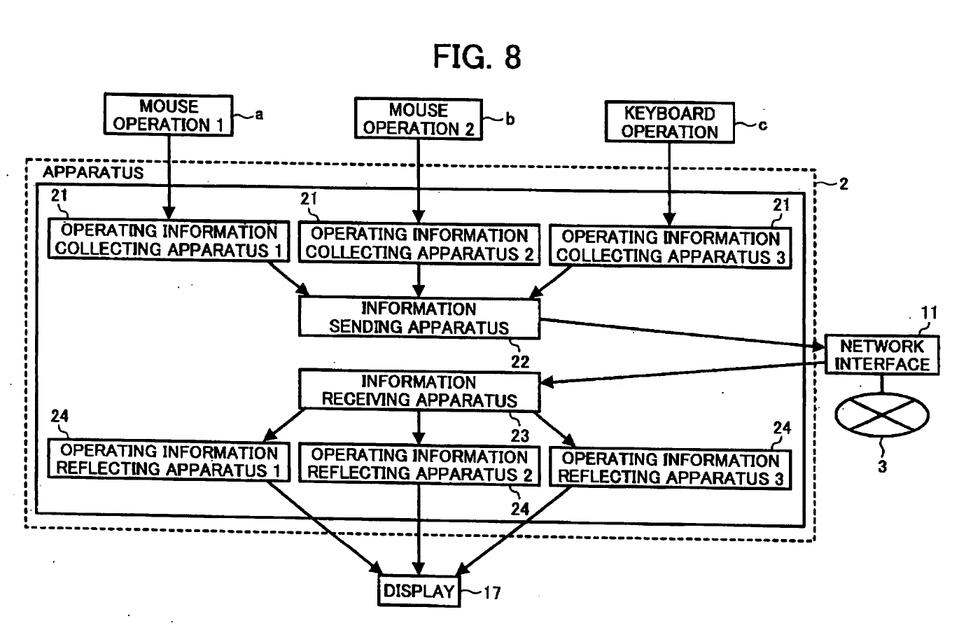

FIG. 8 illustrates the process where plural input devices each generate operating information and the operating information must be reflected on the image provided by the display 17. In FIG. 8, the operating information is acquired by the information processing device 2, and the data flow is illustrated using arrows. Plural operating information reflecting apparatuses 24 are provided to support plural operating information collecting apparatuses 21. Each operating information collecting apparatus 21 acquires different events including event a, event b, and event c created by operation of an input device 16 such as a mouse or keyboard.

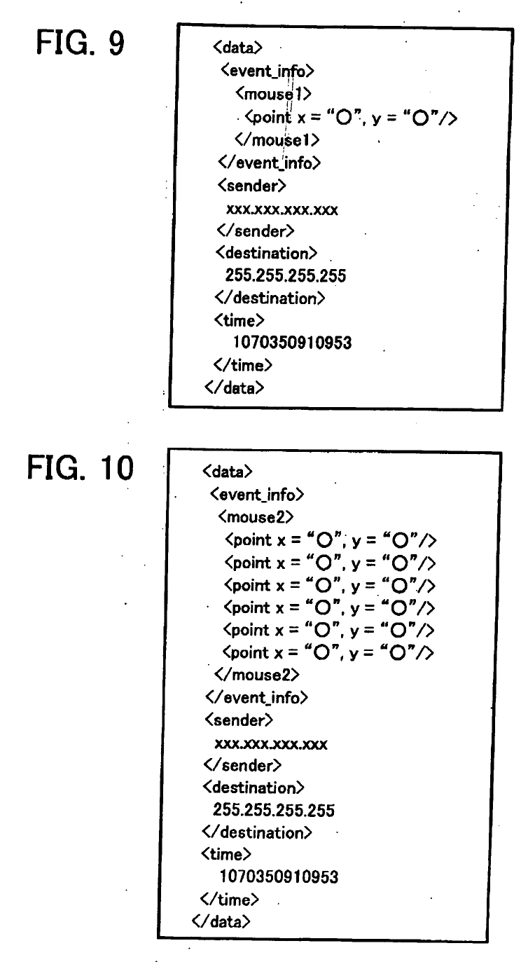

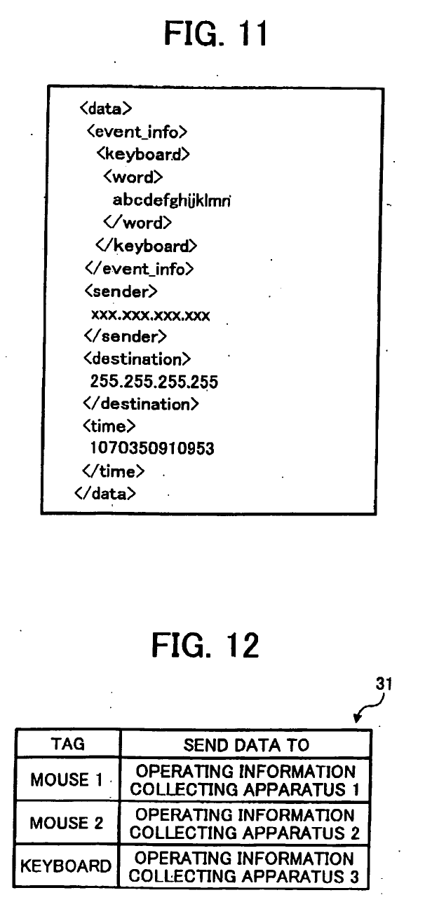

The flow of processing beginning with the acquisition of multiple events such as event a, event b, and event c through the transmission of a message of the operating information is the same as the flow of processing described above with regard to a single event. When an event is acquired, each operating information collecting apparatus 21 generates data such as illustrated by way of example in FIG. 9, FIG. 10, and FIG. 11, respectively. The data object is sent to the information sending apparatus 22 along with the IP address of the destination device. In the data shown in FIG. 9, event information regarding a mouse operation is described. The operating data has a “mouse 1” tag in FIG. 9. The operating data of a second mouse operation (i.e., event b) has a “mouse 2” tag. See FIG. 10. It is preferable not to repeat identifying tags and to obey the naming conventions of XML (cf. FIG. 10 and FIG. 11). In addition, it is preferable to describe the content of the data using the event_info tag if the descriptions can be interpreted by each operating information collecting apparatus 21 and the operating information reflecting apparatus 24 and is based on a description convention of XML. The information sending apparatus 22 transmits plural data objects regarding event a, event b, and event c at a time.

When data, as shown in FIG. 9, FIG. 10 and FIG. 11, is received, the information receiving apparatus 23 sends the data to an appropriate operating information reflecting apparatus 24. For example, the information receiving apparatus 23 would send the received data to operating information reflecting “apparatus 1” of FIG. 8 upon receiving the data illustrated in FIG. 9. Likewise, the information receiving apparatus 23 would send the received data to operating information reflecting “apparatus 2” of FIG. 8 upon receiving the data illustrated in FIG. 10. It is preferable to assign each operating information reflecting apparatus a data object to process based upon the tag name provided in the data object before transmitting the data object to the network 3. In other words, the correspondence shown in table 31 of FIG. 12 will be utilized by the information receiving apparatus 23. When the tag name provided as part of the event_info tag is acquired, it is compared with information of table 31 and a destination of the data is determined. Each operating information reflecting apparatus 24 interprets the received data directed to it by the information receiving apparatus 23, and the image displayed on the display device 17 reflects the newly received operating information data.

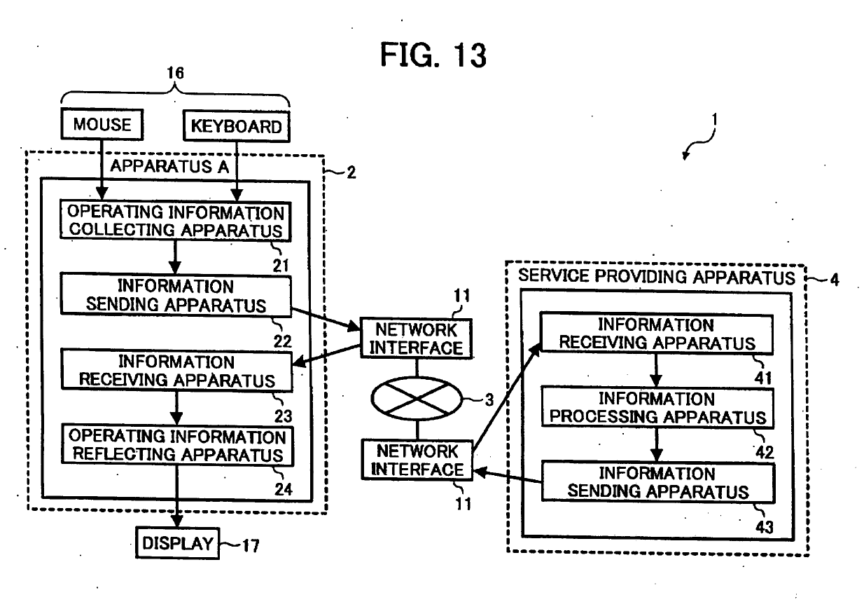

As shown in FIG. 13, a service providing apparatus 4 may be connected to the network 3 of the network system 1. The service providing apparatus 4 includes an information processing device such as a server. The hardware configuration of the service providing apparatus 4 is similar to the information processing device 2 shown in FIG. 2. However, based on a program 20, the service providing apparatus 20 functions differently than the information processing device 2 as the following described processing is executed.

The service providing apparatus 4 provides predetermined services. For one, the service providing apparatus receives a message from the information processing device 2 and converts the message into data of some form. As shown in FIG. 13, the service providing apparatus includes an information receiving apparatus 41, an information processing apparatus 42, and an information sending apparatus 43 which function under the control of executed program 20.

As previously described, the information processing device 2 (Apparatus A) acquires an event (i.e., an operation of the mouse and/or the keyboard) and data regarding the operating information are sent to the information sending apparatus 22. The IP address of a local machine is provided as the destination tag of a data object as illustrated in FIG. 4. In addition, the IP address when the information processing device 2 sends to the information sending apparatus 22 along with the data that an IP address of a local machine was set by destination is done with the IP address of the service providing apparatus 4. It is assumed that the IP address of the service providing apparatus 4 is predetermined. The information sending apparatus 22 transmits the data to the service providing apparatus 4. The service providing apparatus 4 receives the data via the information receiving apparatus 41, an event_info tag is analyzed, predetermined data handling is done via the information processing apparatus 42, and new data is generated. The information sending apparatus 43 transmits the generated data addressed to the address provided in the destination tag. The Apparatus A acquires the data via the information receiving apparatus 23. The apparatus A sends the data to the operating information reflecting apparatus 24. The operating information reflecting apparatus 24 displays the information provided by the data on the display device 17. Consequently, service offered on the network system 1 can be used by the information processing device 2. In addition, as can be seen from this example, the data sent by the information sending apparatus 43 is generated anew by the information processing apparatus 42. However, data prepared beforehand by an apparatus in the service providing apparatus may be transmitted using the information sending apparatus 43.

In other words, at least one of the information sending apparatuses 22 connected to the network 3 sends the operating information to the service providing apparatus 4, a predetermined device, on the network 3. A command for the service providing apparatus 4 to send data to the network 3 is included in the operating information sent by the information sending apparatus 22. The command includes a command to make the service providing apparatus 4 send data to apparatuses on the network 3 including the information sending apparatus 22. In addition, the information sending apparatus 43 in the service providing apparatus 4 carries out the command to send data (e.g., a broadcast).

A description is made of an operative example of the type of service that the service providing apparatus 4 provides. Two examples of services provided are explained below. These services bestow predetermined processing on received data, and then send the data back to at least the originating device.

1. Translation Service

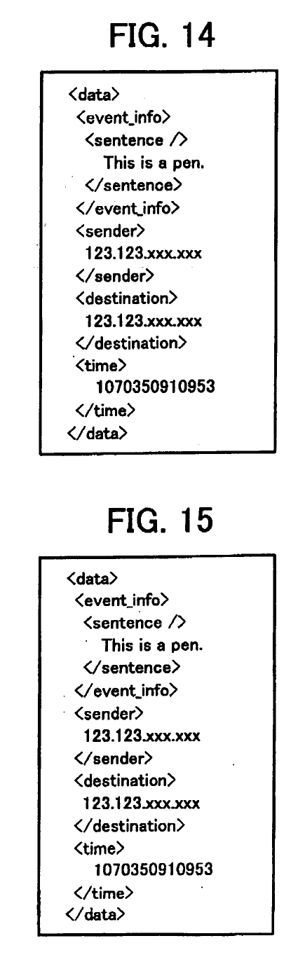

One service is to translate a character string input with a keyboard. The information providing apparatus 2 (Apparatus A of FIG. 13) turns the character string acquired by the operating information collecting apparatus 21 (e.g., “this is a pen”) into data as shown in FIG. 14, and generates message data. The message is transmitted only to the service providing apparatus 4. When the service providing apparatus 4 receives the message, if there is a tag that reflects that the service providing apparatus 4 can interpret the data, then the service providing apparatus 4 does so. If the data can be interpreted by the service providing apparatus 4, the service providing apparatus 4 processes the data and forwards it as a reply to an IP address provided in the destination tag. The character string is acquired on the basis of a sentence tag and is translated with a well-known translation program. Data as shown in FIG. 15 is generated as reply data, by way of example, and the service providing apparatus transmits the message to the IP address provided in the destination tag. When the Apparatus A receives the data, the apparatus A displays the character string (e.g., “This is a pen”) on the display device 17 by interpreting the data. Outside service of operating data generated by information processing device 2 can be readily executed as described above.

2. Smoothing Service of Image Data.

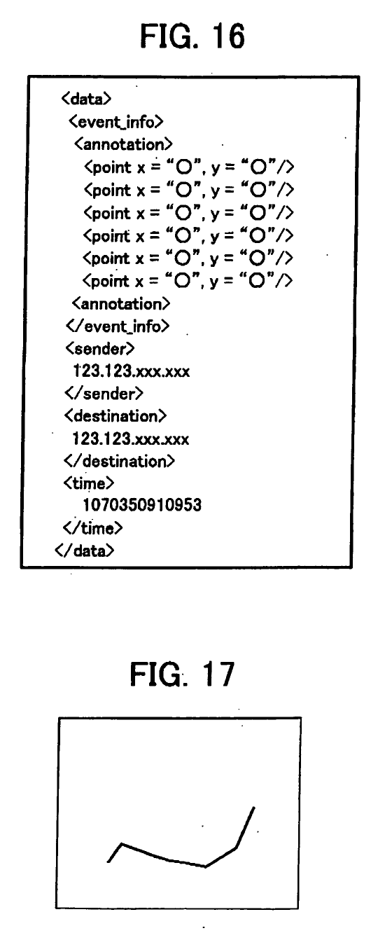

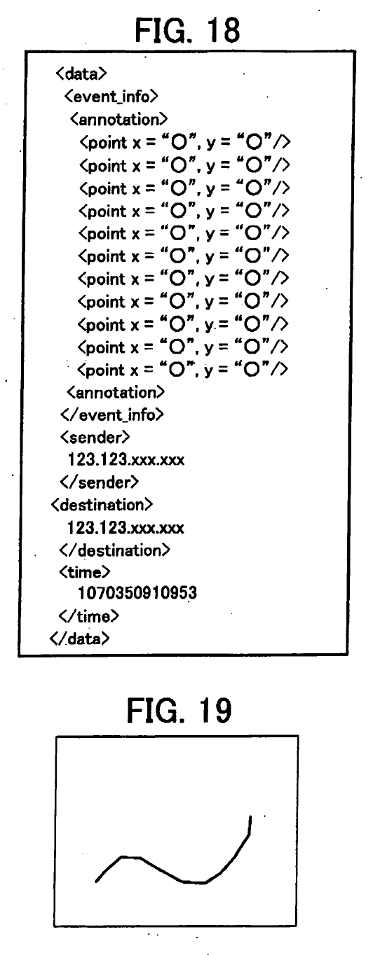

Another service is to smooth the contour of a line drawn by operation of a mouse or a tablet. Apparatus A and an information providing apparatus 2 turn point (i.e., coordinate) information of a mouse acquired by an operating information collecting apparatus 21 into data as shown in FIG. 16. The information providing apparatus 2 transmits a message to the service providing apparatus 4. For this example, it is assumed that the data reflect a diagram as shown in FIG. 17 as if it had been displayed on the screen of the information providing apparatus immediately. The service providing apparatus 4 receives the data, and if there is a tag which reflects that the data can be interpreted, the service providing apparatus 4 handles processing of the data. If the data cannot be interpreted, then the service providing apparatus 4 generates a reply addressed to the IP address identified by the destination tag. The coordinate point data is acquired on the basis of the annotation tag, smoothing data is calculated by the service providing apparatus 4, data such as that shown by way of example in FIG. 18 is generated as reply data, and the service providing apparatus 4 transmits a message to the IP address identified in the destination tag. The Apparatus A receives the message and the display device 17 displays a diagram as shown in FIG. 19 by interpreting the data. As can be seen from comparing FIGS. 17 and 19, the diagram has smoother changes in direction. The diagram illustrated in FIG. 19 is displayed by the information processing apparatus 2. As can be seen from the above described example, outside service of the operating data of the information processing device 2 can be readily processed.

As discussed above, data is transmitted to the network 3 as opposed to being transmitted directly to the display device 17 in order to reflect operation of the input device 16. By using operating data received from the network 3, the picture displayed by the display device 17 reflecting operation of the input device 16 has the same response time to display for each of the plural information processing devices provided on a network. Moreover, each information processing apparatus can take advantage of the outside service and hence utilize the same processing. In addition, data treated by the service device can be sent to other information processing devices by identifying the devices using the destination tag. Alternatively, a broadcast address can be identified in the destination tag in order to service multiple addresses.

Because, according to the invention, data is normally transmitted to the network 3 as opposed to being transmitted directly to the display device 17 in order to reflect operation of the input device 16, difficulties arise when transmitting information to other information processing device 2 and the network 3 is inoperative. Consequently, it is preferable that the information processing device 2 has the ability to process the operating data in the same manner that the network 3 functions based on the program 20, and is able to determine whether transmission and reception of data is possible via the network 3. The information processing device can check whether the network 3 is functioning by broadcasting a predetermined message and determining whether a reply message is returned or, alternatively, the network can be pinged.

On the occasion that it is determined that network 3 is not functioning properly, the information processing device 2 transmits generated message data directly to the information receiving apparatus 23 using the information sending apparatus 22. The information receiving apparatus treats the message as if the message had been received over the network interface 11. Consequently, when the network 3 does not work normally, it is possible to reflect directly operation of the input device 16 on the display device 17.

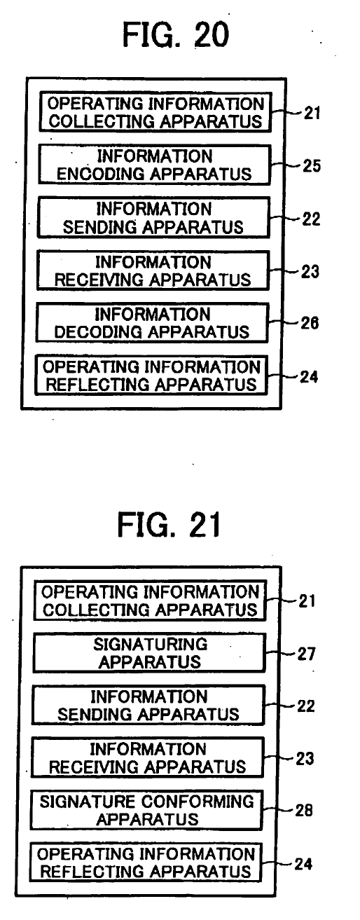

In addition, according to an embodiment of the invention shown in FIG. 20, the information processing device 2 and the service providing apparatus 4 are configured to encode the message data prior to transmission via the network interface 11. The encoding is done under the control of the program 20, and enables transmission of a message encoded using a predetermined code system (information encoding apparatus 35). When data received by the information receiving apparatus 23 is encoded by the above-described coding system, an information decoding apparatus 33 is provided to decode the data. In other words, the information encoding apparatus 35 encodes the data that the operating information collecting apparatus 21 generates, and it is transmitted via the information sending apparatus 22. The information decoding apparatus 36 decodes the received data, and the data is forwarded to the operating information reflecting apparatus 24.

Furthermore, according to an embodiment of the invention shown in FIG. 21, a signature confirming apparatus 38 can be provided to confirm a signature of the data added to the data using a signature apparatus 37 prior to transmission of a message by the information sending apparatus 22. The signature apparatus 37 is configured to add a signature which requires confirmation, prior to the received data being forwarded to the operating information reflecting apparatus. In other words the signaturing apparatus 37 adds a signature to the data generated by the operating information collecting apparatus 21 prior to the data being transmitted by the information sending apparatus 22. The signature confirming apparatus 38 analyzes a signature part of the received data. If confirmation of a signature is provided, the signature confirming apparatus 38 sends data to the operating information reflecting apparatus 24.

As thus described, the information processing device 2 encodes the data or adds a signature instead of merely sending the operating information data to the network. The information processing device 2 thus requires a confirmation process rather than directly forwarding the received data to the operating information collecting apparatus 21 when receiving data. The basic operation of the invention does not require the above described functionality.

The program 20 used by the image processing device 2 may be provided as an encapsulation document. In other words, synchronization between encapsulation documents of plural information processing devices 2 on the network system 1 can be done smoothly by generating an encapsulation document bundling the program 20. In addition, services provided on the network system 1 by the service providing apparatus 4 can be used via an encapsulation document.

Such an encapsulation document has information contents including multimedia files such as pictures or animations accompanying a document file which express the document subject matter. The encapsulation document may have a program group. The program group includes a program configured to read information content on a computer and a program to add a program and at least one function to activate. The encapsulation document has a structure file prescribing the structure of the encapsulation document. Further details regarding encapsulation documents are provided in U.S. Laid-Open Patent Document No. 2003/0014441 or Japanese Laid-Open Patent Document No. 2003-99424, for example, the contents of which are herein incorporated by reference.

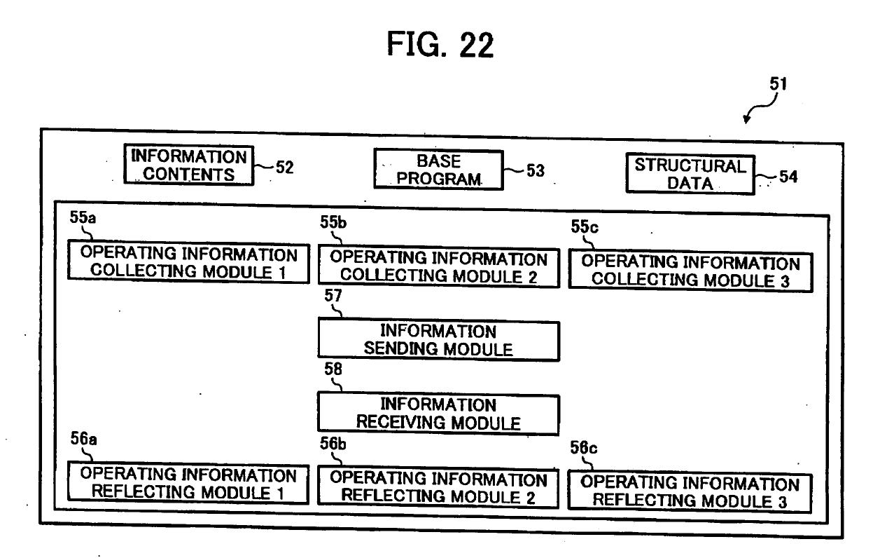

FIG. 22 illustrates an example of the constitution of an encapsulation document 51 configured to provide the data structure of the present invention. The encapsulation document 51 includes program modules regarding information contents 52, a program group 53, and a structure file 54 as its basic constitution. The encapsulation document 51 bundles an operating information acquisition module 55a, an operating information acquisition module 55b, an operating information acquisition module 55c for acquiring user operations, an operating information reflection module 56a, an operating information reflection module 56b, an operating information reflection module 56c for reflecting these operating information, an information transmission of a message module 57, and an information reception module 58 as the second program.

Operations based on the second program illustrated in FIG. 22 are quite similar to the previously described operations regarding FIG. 8. In other words, the operating information acquisition module 55a, the operating information acquisition module 55b, and the operating information acquisition module 55c correspond to the operating information collecting apparatuses 21, respectively, illustrated in FIG. 8. The operating information reflection module 56a, the operating information reflection module 56b, and the operating information reflection module 56c correspond to the operating information reflecting apparatuses 24, respectively. The information transmission of a message module 57 corresponds to the information sending apparatus 22. Lastly, the information reception module 58 corresponds to the information receiving apparatus 23.

The storage medium 18 (FIG. 2) stores the encapsulation document 51 or the document can be downloaded from the Internet in order to be taken advantage of by the information processing device 2.

As thus described, by bundling each program module, operating information can be transmitted by the operation which is same as the operation described with regard to FIG. 8. Moreover, it is possible to synchronize displayed contents between each information processing apparatus 2 and to use services on the network 3 by processing data which is the same as the explanation of FIG. 8.

In addition, the operating information acquisition module 55a and the operating information reflection module 56a are handled by one set. Further, the operating information acquisition module 55b and the operating information reflection module 56b are handled by one set, and the operating information acquisition module 55c and the operating information reflection module 56c are handled by one set. A necessary module can be added or an unnecessary tool (module) can be removed.

Finally, the description provided above, by way of example, enables the display device 17 to reflect operating information generated by the information processing device 2 but received from the network 3. However, the present invention is not limited to operating information regarding display outputs, but could be applied to a loud speaker, or the like, as an output device configured to receive operating information from the network 3.

1. An information processing device comprising:
an interface configured to communicate with a network;
an input device configured to generate operating information;
an output device;
an operating information collecting apparatus configured to collect the operating information of the input device;
an operating information sending apparatus configured to transmit the operating information to the network via the interface;
an operating information receiving apparatus configured to receive data regarding the operating information returned by the network; and
an operating information reflecting apparatus configured to control the output device based on the data received from the network to create an output reflecting the operating information.

2. The information processing device as claimed in claim 1 further comprising:
a checking apparatus configured to determine whether the network is operating normally;
wherein the operating information sending apparatus transmits the operating information to the operating information reflecting apparatus for processing when the network is not operational.

3. The information processing device as claimed in claim 1, wherein the operating information sending apparatus transmits the operating information to all devices on the network as a broadcast via the interface.

4. The information processing device as claimed in claim 1 further comprising:
an information encoding apparatus configured to encode the operating information before transmission to the network; and
an information decoding apparatus configured to decode the data received from the network.

5. The information processing device as claimed in claim 1 further comprising
a signaturing apparatus configured to add a signature to the operating information before transmission to the network; and
a signature confirming apparatus configured to confirm the signature of the data received from the network.

6. The information processing device as claimed in claim 2, wherein the operating information sending apparatus does not transmit the operating information to the operating information reflecting apparatus when the network is operational.

7. A network system including plural information processing devices as claimed in claim 1 connected in a peer-to-peer configuration, wherein:
transmission of the operating information to the network is from a first information processing device to a second information processing device of the plural information processing devices; and
the second information processing device is configured to transmit data regarding the received operating information back to the first information processing device.

8. A network system including at least one information processing device as claimed in claim 1 and further comprising:
a service providing apparatus configured to provide at least one service for the at least one information processing device including,
(a) translating a character string transmitted by one of said at least one information processing devices to the service providing apparatus as operating information, and
(b) smoothing a line image transmitted by one of said at least one information processing devices to the service providing apparatus as operating information.

9. The network system claimed in claim 8, wherein:
data generated by the service providing apparatus is transmitted back to the originating information processing device.

10. The network system claimed in claim 8, wherein:
data generated by the service providing apparatus is broadcast to each of said at least one information processing devices.

11. A data structure stored on a computer readable medium, comprising:
a first program including information contents, a program group, and a structure file; and
a second program including at least one pair of operating information acquisition modules and an operating information reflection module.

12. An information processing device comprising:
an interface configured to communicate with a network;
an input device configured to generate operating information;
an output device;
means for collecting the operating information of the input device;
means for transmitting the operating information to the network via the interface;
means for receiving data regarding the operating information returned by the network; and
means for controlling the output device based on the data received from the network to create an output reflecting the operating information.

13. A method for processing operating information using a network, comprising the steps of:
using an input device to generate operating information;
collecting the operating information of the input device;
transmitting the operating information data to the network;
receiving data from the network regarding the transmitted operating information data; and
controlling an output device based on the data received from the network to create an output reflecting the operating information.

14. The method for processing operating information as claimed in claim 13 further comprising the step of:
determining whether the network is operating normally; wherein the operating information is transmitted to the network when the network is operational or the operating information is processed remotely and used to control the output device when the network is dysfunctional.

15. The method for processing operating information as claimed in claim 13,
wherein the transmitting step includes the step of broadcasting the operating information to each device on the network.

16. The method for processing operating information as claimed in claim 13 further comprising the steps of:
encoding the operating information before transmission to the network; and
decoding the data received from the network.

17. The method for processing operating information as claimed in claim 13 further comprising the steps of:
adding a signature to the operating information before transmission to the network; and
confirming the signature of the data received from the network.

18. The method for processing operating information as claimed in claim 13, wherein the collecting step comprises the steps of:
determining whether an event has occurred which generates the operating information; and
generating data based on the operating information and including an identifier reflecting that the data includes operating information for transmission to the network.

19. The method for processing operating information as claimed in claim 13, wherein the receiving step comprises the steps of:
awaiting data from the network; and
upon receiving data, creating a data object using the received data.

20. The method for processing operating information as claimed in claim 19, wherein the controlling step comprises the steps of:
analyzing the data object;
discarding the data object when the data object does not have an identifier reflecting that the data object includes operating information.
